(19) United States
(12) Patent Application Publication
(10) Pub. No.: US 2014/0228014 A1
(43) Pub. Date: Aug. 14, 2014

(54) Method, System and Computer Program for Remotely Configurable Mobile Application

(71) Applicant: MISTRAL MFS OY, Oulu (FI)

(72) Inventors: Timo Tervo, Oulu (FI); Nicolas Aubry, Kempele (FI)

(73) Assignee: MISTRAL MFS OY, Oulu (FI)

(21) Appl. No.: 13/765,499

(22) Filed: Feb. 12, 2013

(51) Int. Cl. H04W 8/22

(52) U.S. Cl. CPC H04W 8/22
USPC 455/419

(57) ABSTRACT

The invention relates to a method, a system and computer programs for implementing a remotely configurable mobile application for a mobile client device supporting services that are prone to changes due to external conditions. In the method, the initial configuration of the mobile application and changes to the initial configuration can be implemented on a configuration server without disturbing the application use. The configuration server also adapts the application towards a service platform and allows managing the application's use and is independent of any operating system of the mobile client device or the service platform.

### TECHNICAL FIELD

The invention relates to a method for creating a remotely configurable mobile application. The invention also relates to a system of remotely configurable mobile application utilizing the method. Further, the invention relates to a computer program product implementing the tools and means for creating and managing a remotely configurable mobile application. Finally, the invention relates also to a computer program product implementing a remotely configurable mobile application.

### BACKGROUND

In the mobile payment ecosystem, and particularly in high-growth markets, there is a need to update and modify consumers', agents' or merchant's set of features frequently. Similar needs are met in other areas of business such as insurance or rental related services.

Such need arises from the fact that in growth markets services such as financial or insurance services are very young and new features and updates are introduced with high frequency. At growth market end-users also frequently elevate from one consumer category to another and gain access to new services. For example, the end-users may initially use a mobile payment service without giving any legal documents (if permitted by applicable regulations) to first use closed-loop products before executing proper Know-Your-Customer process and gaining access to semi-closed or open loop services, where features might be broader.

As a consequence, companies aiming at providing services such as financial, insurance or rental services through mobile applications in high-growth markets and in a context of limited connectivity are constantly facing the challenge of updating and modifying the set of features available on their mobile service applications.

In developed markets, frequent features update or modification needs are currently solved by re-downloading and re-installing a complete mobile application over the air via IP channel.

In high-growth markets most users may not have a data channel, for example a data subscription, available to execute such re-download and re-installation of the mobile applications and thus, the most common strategy to deploy new or updated features is to visit an agent (i.e. a correspondent) who can execute application update via manual installation from a memory card or side-load with Personal Computer (PC) or the like.

Several different solutions for configuring mobile devices automatically have been presented. These solutions are typically based on creating matching definition files both on server side and application or device side, providing specific configuration and identification modules that are integrated into a larger network management system or allowing users to download programs or applications that partially reconstitute the existing programs or applications. All of these solutions typically also require well-established network conditions and data subscriptions with high data transfer capability. Also, methods for updating simple settings of mobile client devices and mobile applications are widely known.

### SUMMARY OF SOME EXAMPLES OF THE INVENTION

The object of the present invention is to provide a method for remotely managing, updating and modifying a mobile application's set of functionality and menu structure through software configuration instead of software re-installation and delivering the data required for service transaction processing to service systems over limited connectivity and narrow communication channels.

The object of the present invention is also to provide a system where new or updated service features can be delivered to the remotely configurable mobile application in a compressed and secured binary format that can fit into a delivery message of a limited capacity that would not set high requirements for a communication channel over which the message is being delivered. This allows the remotely configurable mobile application to gain access to new or updated services without a need for a complete re-installation of the application. Furthermore, the object of the present invention is to allow managing the use and remote controlling of the set of functionality available in the mobile application,

The objects of the present invention are fulfilled by providing a method for:
initializing a remotely configurable mobile application in a mobile client device;
constructing an initial menu and related data types for the remotely mobile application in the mobile client device;
providing remote configuration tools for defining changes on a configuration server to the menu and functionality of the remotely configurable mobile application without requiring re-installation of the said application in the mobile client device and causing a break in using the said application;
creating encrypted, communication channel independent configuration and management messages between the remotely configurable mobile application in the mobile client device and the configuration server for changing the menu and functionality of the said application remotely and dynamically without requiring reinstallation of the said application and causing a break in using the said application in the mobile client device;
changing the menu and functionality of the mobile application remotely and dynamically without requiring re-installation of the said application and causing a break in using the said application in the mobile client device;
disabling or enabling the use of the remotely configurable mobile application in the mobile client device by utilizing the encrypted, communication channel independent configuration and management messages between the remotely configurable mobile application in the mobile client device and the configuration server; and
blocking or unblocking the use of the remotely configurable mobile application in the mobile client device by utilizing the encrypted, communication channel independent configuration and management messages between the remotely configurable mobile application in the mobile client device and the configuration server.

Further, the objects of the present invention are fulfilled by providing a system comprising:
At least one configuration server configured to construct an initial menu, related data types and functionality of a remotely configurable mobile application in a mobile client device and implement changes to the initial menu and functionality of the remotely configurable mobile application in a mobile client device without reinstalling the mobile application and causing a break in the use of the application. The configuration server is also configured to send encrypted, communication channel independent configuration and management messages to the mobile client device with the remotely configurable mobile application for changing the menu of the application remotely and dynamically without requiring re-installation of the application and causing a break in using the application. Further, the configuration server is configured to disable, enable, block or unblock use of the remotely configurable mobile application in the mobile client device by utilizing the encrypted, communication channel independent configuration and management messages;
At least one mobile client device configured to initialize a menu of the remotely configurable mobile application and to present the menu and functionality for the remotely configurable mobile application for allowing a user to send and receive secure service transactions. Also, the mobile client device is configured to receive encrypted, communication channel independent configuration and management messages from the configuration server and to change the menu and functionality of the remotely configurable mobile application according to the received configuration message without requiring re-installation of the application and causing a break in using the application; and
At least one platform server configured to receive messages from the configuration server containing transaction data, process transaction data received from the configuration server, send messages to the configuration server containing a response to the received transaction data, and store the received and processed transaction data.

Also, the objects of the present invention are fulfilled by providing a computer program of a content server comprising:
Computer readable code for initializing a remotely configurable mobile application in a mobile client device;
Computer readable code for constructing an initial menu, related data types and functionality for the remotely configurable mobile application;
Computer readable code for configuring the menu and functionality of the remotely configurable mobile application remotely by utilizing encrypted, communication channel independent configuration and management messages without requiring re-installation of the application and causing a break in using the application;
Computer readable code for sending encrypted, communication channel independent configuration and management messages to the remotely configurable mobile application in the mobile device;
Computer readable code for disabling or enabling the use of the remotely configurable mobile application in the mobile client device by utilizing encrypted, communication channel independent configuration and management messages; and
Computer readable code for blocking or unblocking the use of the remotely configurable mobile application in the mobile client device by utilizing encrypted, communication channel independent configuration and management messages.

Finally, the objects of the present invention are fulfilled by providing a computer program in a mobile client device comprising:
Computer readable code for initializing a menu for a remotely configurable mobile application;
Computer readable code for receiving encrypted, communication channel, independent configuration and management messages from a configuration server;
Computer readable code for executing configuration of the menu and functionality of the remotely configurable mobile application through remote, encrypted, communication channel independent configuration and management messages without requiring re-installation of the application and causing a break in using the said application.

### BRIEF DESCRIPTION OF THE DRAWINGS

The present invention will become more fully understood from the detailed description given herein below and accompanying drawings which are given by way of illustration only, and thus are not limitative of the present invention and wherein

FIG. 1 shows a schematic representation of a system for a remotely configurable mobile application;

FIG. 2 shows a flow chart describing an exemplary high-level scenario for initialization of a remotely configurable mobile application and changing the menu and functionality of the initial remotely configurable mobile application in a mobile device from a configuration server;

FIG. 3 shows a flow chart describing an exemplary high-level scenario for disabling and enabling a remotely configurable mobile application in a mobile client device from a configuration server;

FIG. 4 shows a flow chart describing an exemplary high-level scenario for blocking and unblocking a remotely configurable mobile application in a mobile client device from a configuration server;

FIG. 5 shows a flow chart describing an exemplary high-level scenario for a complete service transaction;

FIG. 6 shows an exemplary detailed scenario for a certain type of service transaction in case of a remotely configurable mobile financial application as an exemplary embodiment; and

FIG. 7 shows an example of initializing and modifying the menu and functionality of a remotely configurable mobile application in a configuration server by utilizing the tools with graphical user interface for configuration.

### DETAILED DESCRIPTION OF THE PREFERRED EMBODIMENTS AND DETAILED DESCRIPTION OF THE DRAWINGS

In the following description, considered embodiments are merely exemplary, and one skilled in the art may find other ways to implement the invention. Although the specification may refer to “an”, “one” or “some” embodiment(s) in several locations, this does not necessarily mean that each such reference is made to the same embodiment(s), or that the feature only applies to a single embodiment or all embodiments. Single feature of different embodiments may also be combined to provide other embodiments.

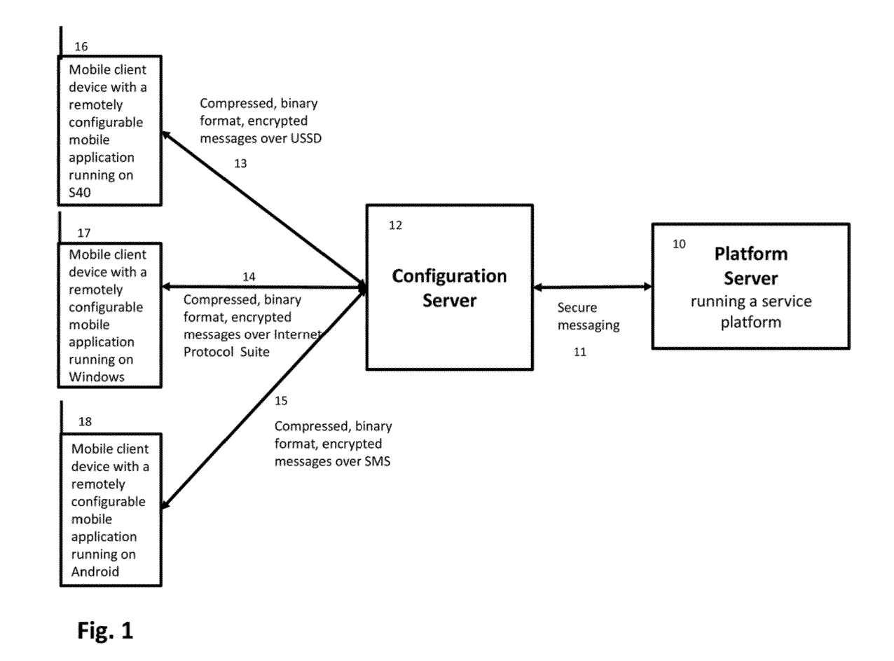

FIG. 1 describes an exemplary embodiment of the system for a remotely configurable mobile application and shows that the system advantageously consists of three main components being at least one configuration server 12, at least one platform server 10 running the actual service platform and one or more mobile client devices 16-18 with a remotely configurable mobile application running on any mobile operating system (OS) such as Android, Windows Mobile, Series40 (S40), Sailfish, or iPhone OS, for example, but not limited to these. Advantageously, the configuration of the mobile application is created and the mobile application is managed in the configuration server 12 and the configuration server and one or more mobile client devices may communicate by utilizing compressed, binary format, encrypted communication and management messages 13-16 that are sent over, for example but not limited to, a limited, narrow communication channel such as Short Message Service (SMS), Unstructured Supplementary Service Data (USSD) or Internet Protocol Suite (IP Suite). A platform server 10 runs the actual service platform and is independent of the configuration server 12. The configuration server may communicate with the platform server through a secure connection and communication channel 11.

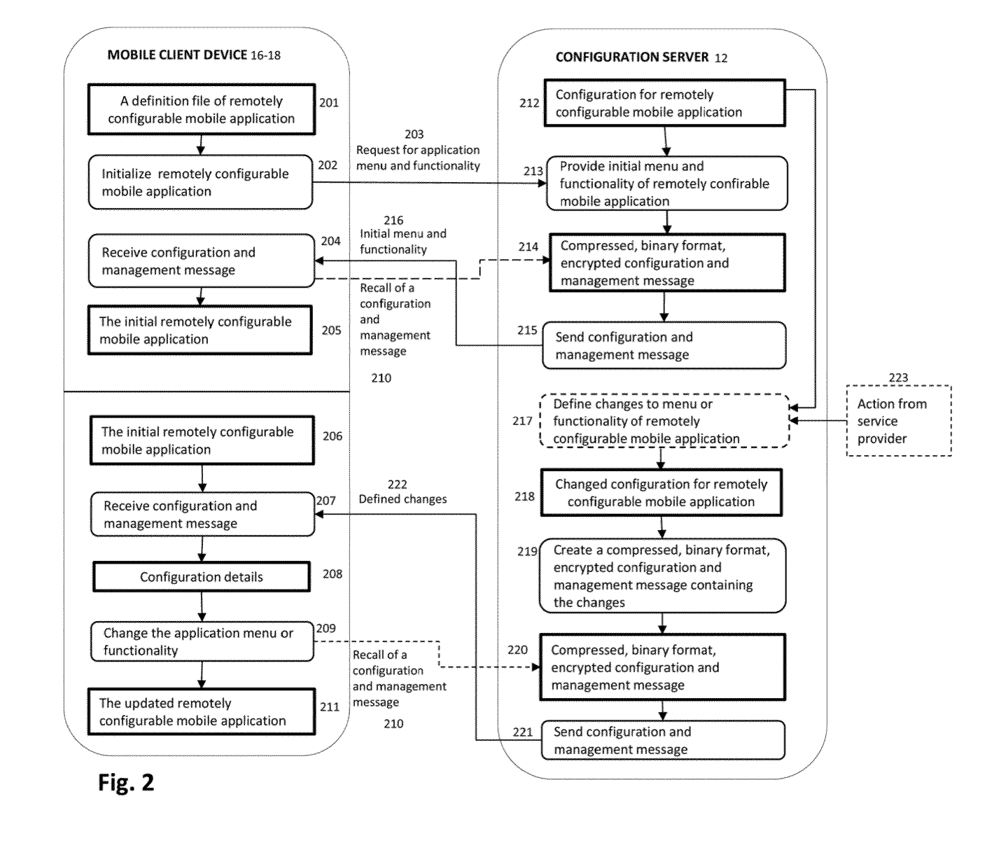

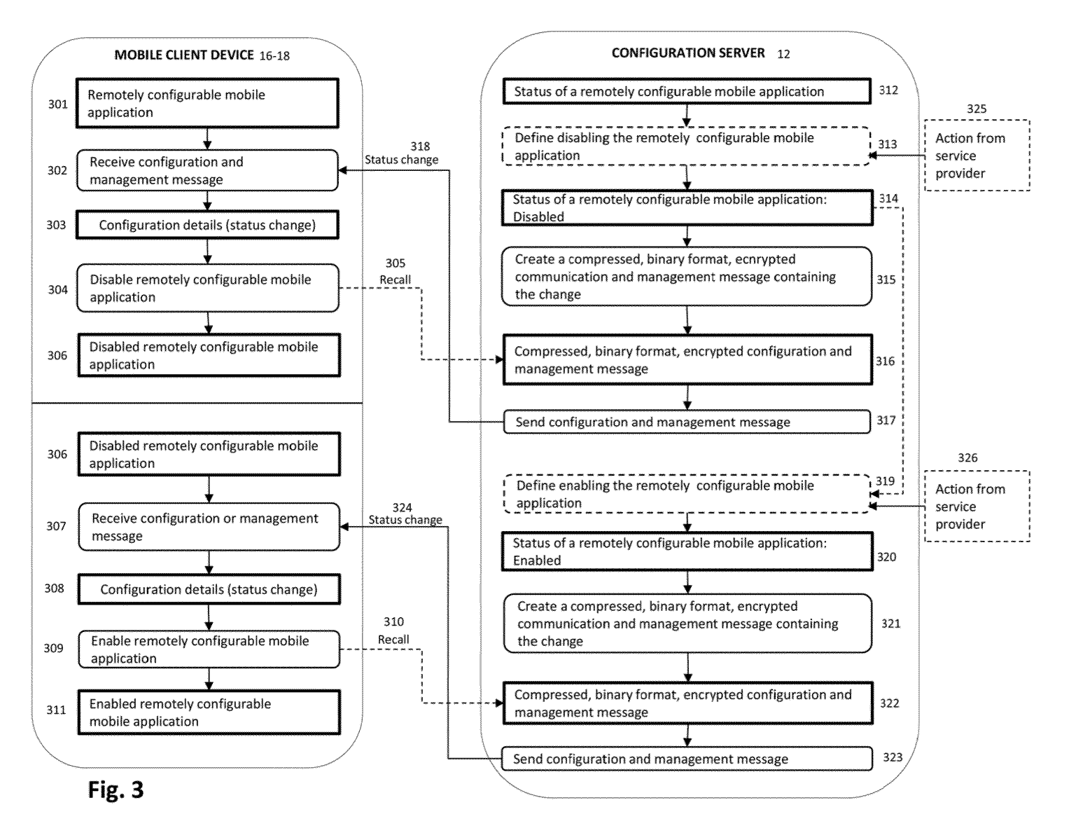

The main steps of the method according to the invention are shown as exemplary flow charts in FIGS. 2, 3, and 4.

FIG. 2 illustrates a flow chart that describes exemplary method steps for initialization of a remotely configurable mobile application and exemplary method steps for changing the menu and functionality of the remotely configurable mobile application through configuration server. The remotely configurable mobile application is initialized 202 in the mobile client device by installing a definition file 201 for the mobile application, which then after installation enables requesting the menu and functionality for the application 203 from the configuration server holding the configuration of the application 212 according to a service that the application is matched with and provides the initial menu, related data types and functionality 213 in one or more compressed, binary format configuration and management messages 214. The configuration and management message 214 is sent to the remotely configurable mobile application in the mobile client device 215-216 and once the message containing the configuration data is received 204, the initial version of the application is ready to use 205. Advantageously, changes to the running initial version of the application 206 can be defined and implemented on a configuration server 217-218 while the mobile application is running the user's mobile device based on the current configuration of the application 212 which is stored in the server and the use of the application is not disturbed while the changes are defined at the configuration server 217. The configuration changes are typically triggered by a service provider 223. The configuration changes 218 are passed to the mobile client device with the remotely configurable mobile application in a compressed, binary format configuration and management message 219-222. After the message is received 207 the menu and functionality of the mobile application are ready to be changed 209 immediately according to the received configuration details 208 and the application stays ready for use with the updated menu and functionality 211.

FIG. 3 illustrates a flow chart that describes exemplary method steps of one embodiment for managing a remotely configurable mobile application, namely disabling and enabling the mobile application in a mobile client device from a configuration server.

According to the exemplary method steps for disabling the remotely configurable mobile application in the mobile client device in FIG. 3, the configuration server 12 is aware of the status of the mobile application in the mobile client device 312 and disabling the application is advantageously defined in the configuration server 313, which then tracks the status change 314. The configuration server also advantageously creates a compressed and encrypted binary format configuration and management message containing the status change information 316 for disabling the application 316 and then sends 317 the message over a communication channel 318 such as SMS or USSD, for example, but not limited to these, to the the mobile application in the mobile client device. Once the message for disabling 302 the application is received, the mobile application may be disabled 304 according to the received configuration details 303 and can operate accordingly 306. Defining disabling the application 313 is an application management action that requires interaction from a service provider controlling the use of the applications and therefore they may be triggered based on an action taken by the service provider 326.

According to the exemplary method steps for enabling the previously disabled remotely configurable mobile application in the mobile client device in FIG. 3, the configuration server 12 is aware of the status of the mobile application in the mobile client device 314 and enabling the application is advantageously defined in the configuration server 319, which then tracks the status change 320. The configuration server also advantageously creates a compressed and encrypted binary format configuration and management message containing the status change information 321 for enabling the application 322 and then sends 323 the message over a communication channel 324 such as SMS or USSD, for example, but not limited to these, to the mobile application in the mobile client device. Once the message for enabling the application 307 is received, the mobile application may be enabled 309 according to the received configuration details 308 and can operate accordingly 311. Defining enabling the application 319 is an application management action that requires interaction from a service provider controlling the use of the applications and therefore they may be triggered based on an action taken by the service provider 326.

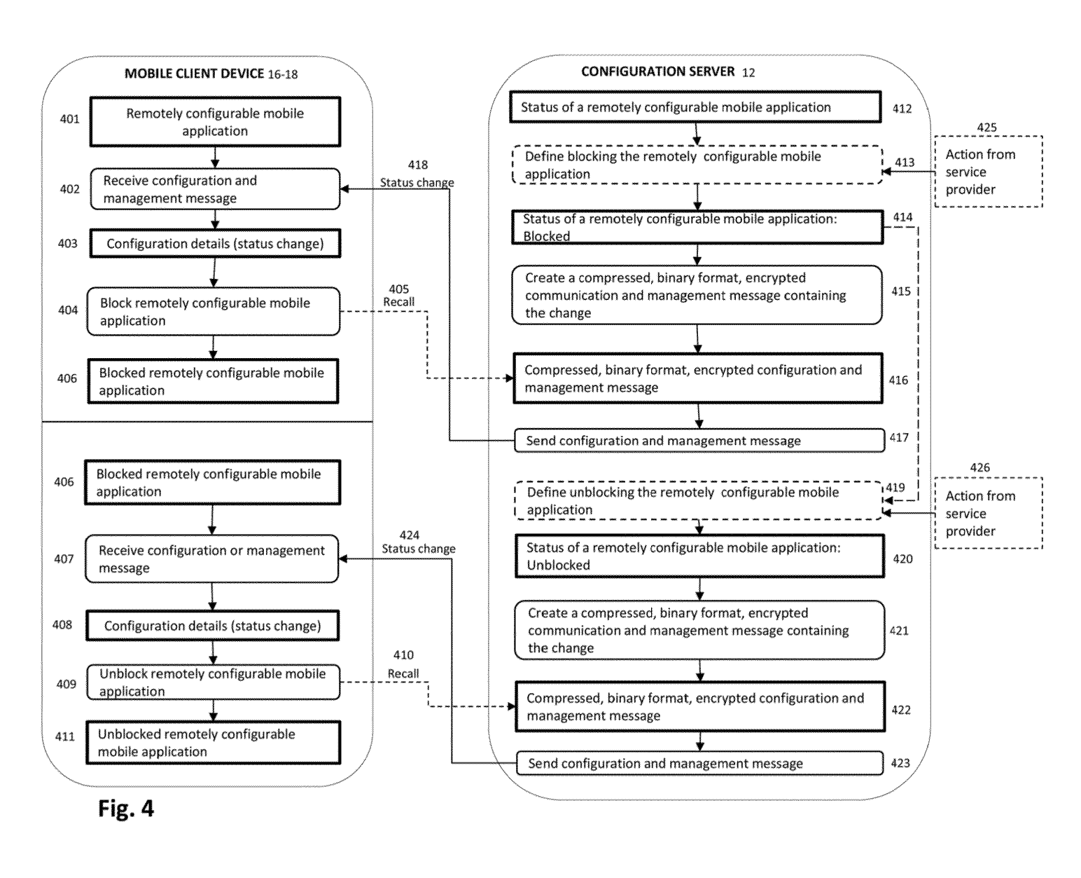

FIG. 4 illustrates a flow chart that describes exemplary method steps of another embodiment for managing a remotely configurable mobile application, namely blocking and unblocking the mobile application in a mobile client device from a configuration server.

According to the exemplary method steps for blocking the remotely configurable mobile application in the mobile client device from use in FIG. 4, the configuration server 12 is aware of the status of the mobile application in the mobile client device 412 and blocking the application is advantageously defined in the configuration server 413, which then tracks the status change 414. The configuration server also advantageously creates a compressed and encrypted binary format configuration and management message containing the status change information 415 for blocking 416 the application and then sends 417 the message over a communication channel 418 such as SMS or USSD, for example, but limited to these, to the mobile application in the mobile client device. Once the message for blocking the application is received 402, the mobile application may be blocked 404 according to the received configuration details 403 and can operate accordingly 406. Defining blocking the application 413 is an application management action that requires interaction from a service provider controlling the use of the applications and therefore they may be triggered based on an action taken by the service provider 425.

According to the exemplary method steps for unblocking the previously blocked remotely configurable mobile application in the mobile client device from use in FIG. 4, the configuration server 12 is aware of the status of the mobile application in the mobile client device 414 and unblocking the application is advantageously defined in the configuration server 419, which then tracks the status change 420. The configuration server 12 also advantageously creates a compressed and encrypted binary format configuration and management message containing the status change information 421 for unblocking the application 422 and then sends 423 the message over a communication channel 424 such as SMS or USSD, for example, but limited to these, to the mobile application in the mobile client device. Once the message for unblocking the application 407 is received, the mobile application may be unblocked 409 according to the received configuration details 408 and can operate accordingly 411. Defining unblocking the application 419 is an application management action that requires interaction from a service provider controlling the use of the applications and therefore they may be triggered based on an action taken by the service provider 426.

As illustrated in FIGS. 2, 3, and 4, the method also advantageously implements a roll-back and recall of configuration and management messages passed between a mobile client device with a remotely configurable mobile application and a configuration server as presented for example in phases 210, 305, 310, 405, and 410. It may be triggered by the application in a situation where consistency between received configuration and management message and the current status or configuration of the application is not clear or complete.

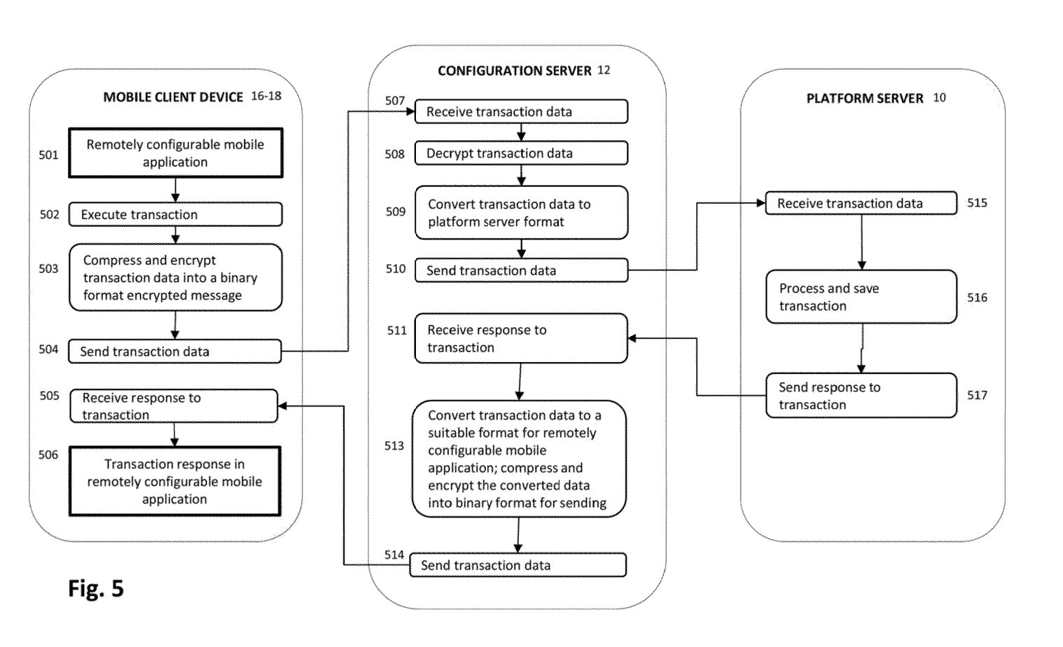

### Exemplary Embodiment 1 Based on FIGS. 2 and 5

FIG. 5 is an exemplary and high-level flow chart illustration of an end-to-end service transaction from a mobile client device 16-18 with a remotely configurable mobile application via a configuration server 12 to a platform server 10 running the service platform which processes the service transaction in question 516 and backwards then delivering the transaction response back to the mobile client device 16-18 with the application via the configuration server 12. The remotely configurable mobile application 501 runs the mobile client device and a service transaction is executed 502 by an application user, the transaction data is compressed into a binary format, encrypted message 503 and sent to the configuration server 504. Advantageously, the configuration server receives the transaction data 507, decrypts the data 508, converts the data into a format acknowledged by the platform server 609 and then sends the transaction forward 510 to the platform server 10. The platform server running the service platform processes and saves the transaction 516 after the transaction data has been received 515. After the transaction is processed 516, a transaction response is sent back to the configuration server 517. After receiving the response 511, the configuration server converts the transaction response to a format acknowledged by the mobile application, encrypts the converted data and compresses it into binary format for sending 513 and sends the response to transaction back to the mobile application 514 running in the mobile client device. After receiving the response to the transaction 505, the mobile application acts according to the response 506.

In one advantageous embodiment of the invention, the invention has advantageously at least three main elements as also shown in FIG. 1:
A remotely configurable mobile application in a mobile client device 16-18 that runs on any mobile OS such as Android, Windows Mobile, S40, SailFish, or iPhone OS, for example, but not limited to these;
A configuration server 12 providing the tools and means for remote configuration of the mobile application regardless of the operating system of the mobile client device 16-18 and enabling communication with the mobile client device running the mobile application through a narrow communication channel by utilizing encrypted, communication channel independent messages 13-15 that allow communication also in a low-connectivity context and communication with a platform server 10 running the actual service platform also through a secure communication channel 11; and
The platform server 10 running the actual service platform connected with a configuration server 12 through a secure communication channel 11.

In this advantageous exemplary embodiment of the invention the remotely configurable mobile application in the mobile client 16-18 may render a set of functionalities implemented advantageously as transaction forms and defined remotely in the configuration server 12. Each transaction form may implement a specific service use case that may depend on the area of service supported by the application such as financial, insurance related or rental service, for example. The remotely configurable mobile application allows a user to execute service transactions 502 by posting a transaction request data 503-504 through utilizing one of the available transaction forms to the configuration server. The configuration server optimizes 511, secures 513, and transports 514 data between the mobile application in the mobile client and the configuration server both in a limited and non-limited connectivity context. The data can be configuration data, application management data or service transaction related data acknowledged by the configuration server and the remotely configurable mobile application.

In this advantageous exemplary embodiment of the invention the configuration server 12 creates and manages the set of service transaction forms that need to be rendered and made available to the remotely configurable mobile application in the mobile client, for example in phases 212-213 or 217-218 in FIG. 2, and receives service transaction request data 507 submitted by the application 504 through one of the available transaction forms 502. Advantageously, the configuration server 12 acts as a gateway towards the platform server 10 running the service platform by forwarding the transaction request data 510 to the platform server and processing the incoming transaction result and response 511-514 back to the remotely configurable mobile application in the mobile client device 16-18.

Advantageously, the configuration server 12 provides a graphical user interface through which a service provider is able to create and manage the set of service transaction forms, for example in phases 212-213 or 217-218 in FIG. 2, and remotely control the use of the mobile applications running in the mobile client devices, for example in phases 313 and 319 in FIGS. 3 or 413 and 419 in FIG. 4.

The configuration server 12 also takes care of converting the sent and received transaction data into a format acknowledged by the platform server 10 and the remotely configurable mobile application in the mobile client device 16-18 as presented in phases 509 and 513, for example. The data may also be configuration data, for example in phases 212 or 218 in FIG. 2, or application management data, for example in phases 314 and 320 in FIGS. 3 or 414 and 420 in FIG. 4, acknowledged by the configuration server and the remotely configurable mobile application. The data is passed between the configuration server and the remotely configurable mobile application in the mobile client device in encrypted, communication channel independent configuration and management messages which are compressed into binary format and therefore may advantageously also be operable in a limited-connectivity context over narrow communication channels such as SMS or USSD, for example, but limited to these.

Advantageously, the state of the each instance of the remotely configurable mobile application, as well as the state of the platform server, is stored in a database on the configuration server, This allows the configuration server to be constantly aware of the situation of each instance of the remotely configurable mobile application running in the mobile client devices and using the service as well as dynamically adapt towards any service platform running on the platform server by mapping the received form data with parameters of the platform server Application Provider Interface (API).

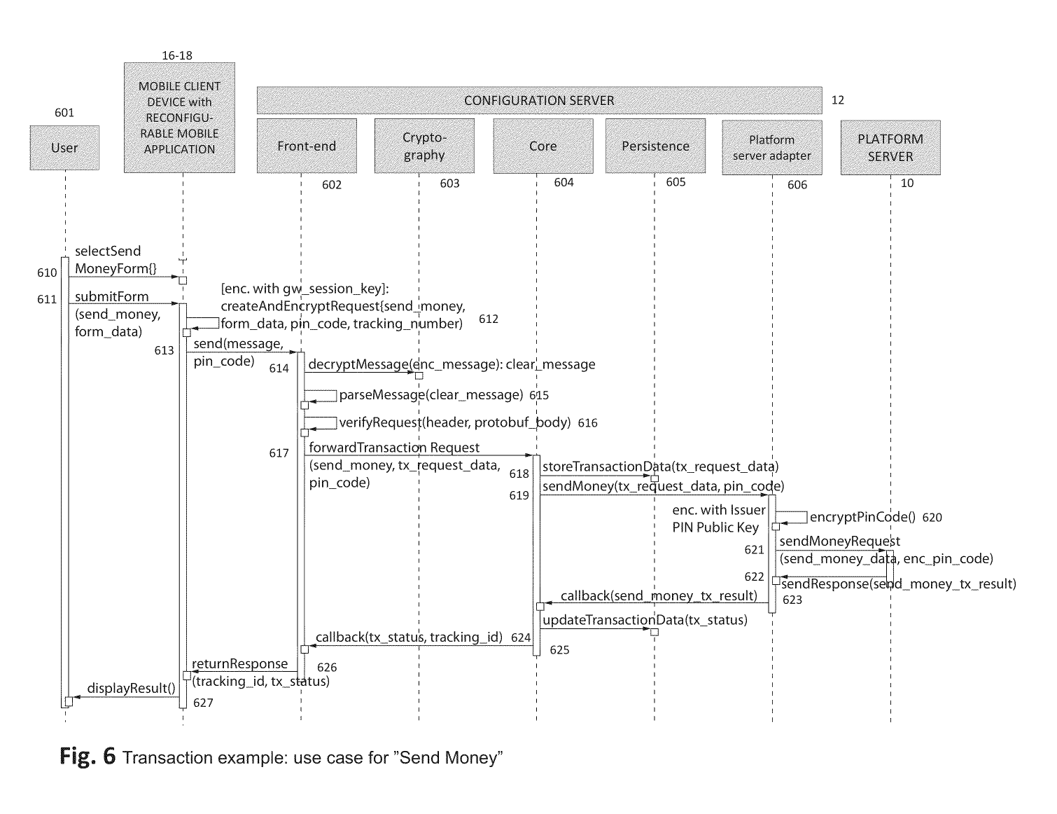

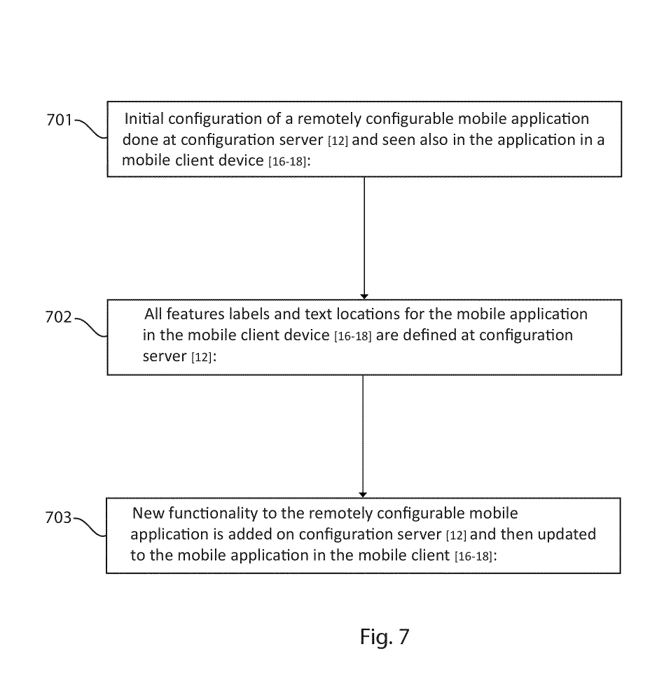

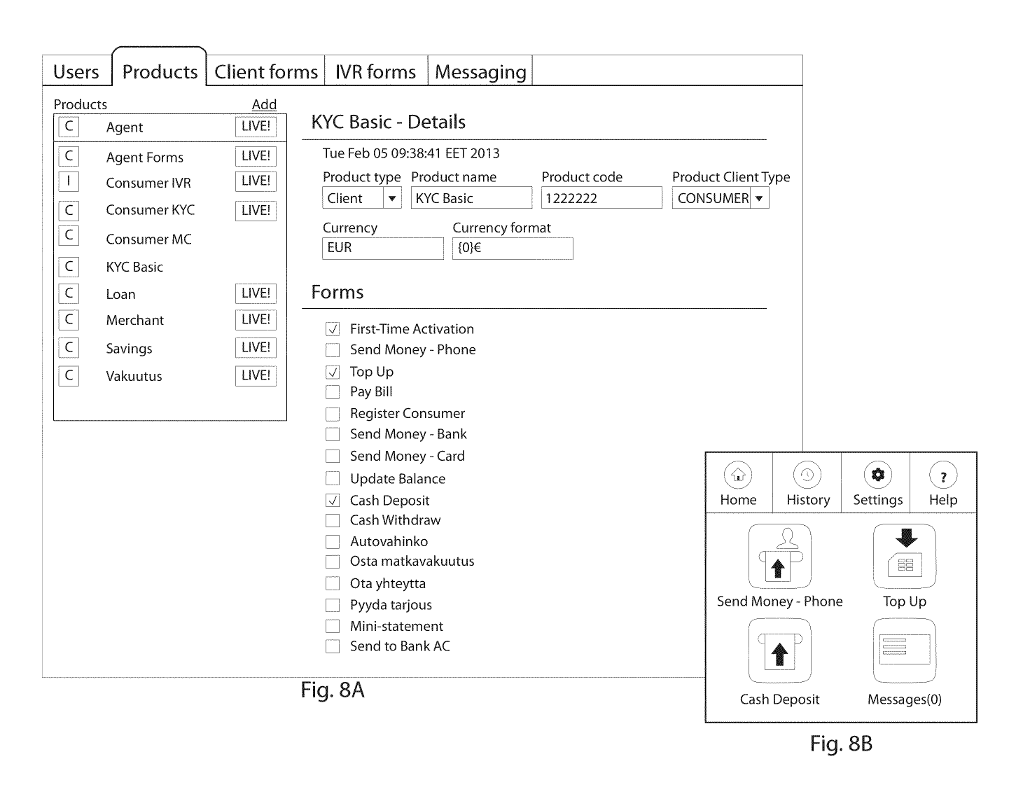

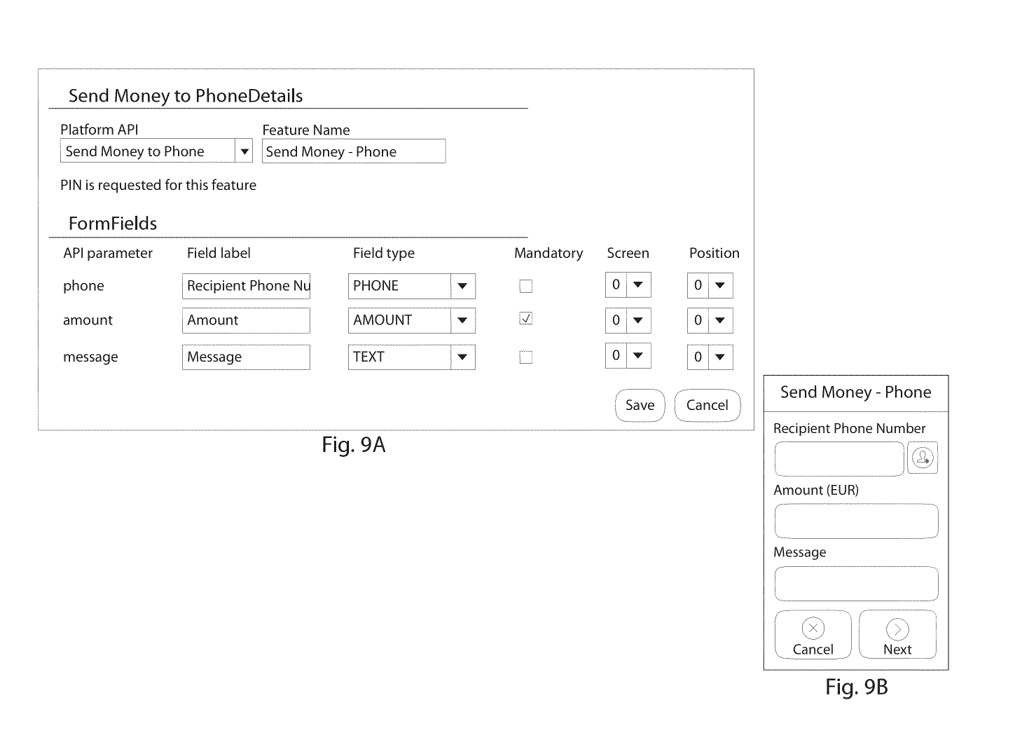

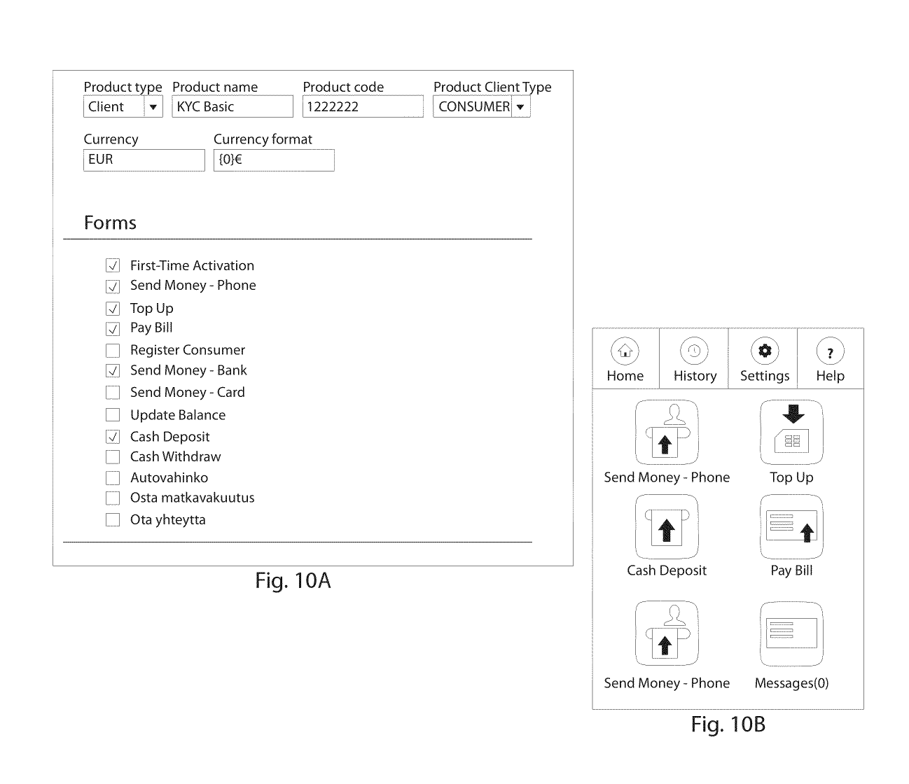

### Exemplary Embodiment 2: A Remotely Configurable Mobile Financial Application Based on FIGS. 6 and 7

In this exemplary embodiment of the invention, a remotely configurable mobile financial application is presented as a more detailed example of an advantageous implementation of a service utilizing the invention. In this embodiment the system for a remotely configurable mobile financial application advantageously also consists of at least three main elements as described in FIG. 1:
A remotely configurable mobile application in mobile client device 16-18 that runs on any mobile OS such as Android, Windows Mobile, S40, SailFish, or iPhone OS, for example, but not limited to these:
A configuration server 12 providing the tools and means for remote configuration of the mobile application 16-18 regardless of the operating system of the mobile client device and enabling communication with the mobile client device running the mobile application through a narrow communication channel by utilizing encrypted, communication channel independent messages 13-15 that allow communication also in a low-connectivity context and communication with a platform server 10 running the actual service platform also through a secure communication channel 11, and
The platform server 10 running the actual service platform connected with a configuration server 12 through a secure communication channel 11.

In this advantageous embodiment of the invention, like illustrated in FIG. 5 on high level, the remotely configurable mobile application in the mobile client 16-18 renders a set of functionalities advantageously implemented as transaction forms and defined remotely in the configuration server. Each transaction form may correspond to and implement a specific financial use case such as Send Money, Pay Bill or Airtime Top-Up, for example, but not limited to these. The remotely configurable mobile application allows a user to execute service transactions 502 by posting transaction request data using one of the available transaction forms to the configuration server 503-504. The configuration server optimizes 511, secures 513, and transports 514 data between the mobile application in the mobile client and the configuration server both in a limited and non-limited connectivity context. The data can be configuration data, application management data or service transaction related data acknowledged by the configuration server and the remotely configurable mobile application.

In this advantageous exemplary embodiment of the invention the configuration server creates and manages the set of financial service transaction forms such as Send Money, Pay Bill or Airtime Top-Up, for example, that need to be rendered and made available to the remotely configurable mobile financial application in the mobile client device. The configuration server also receives financial service transaction request data submitted by the mobile application through one of the available transaction forms. The configuration server acts as a gateway towards the platform server running the financial service platform by forwarding the financial transaction request data to the platform server and processing the incoming financial transaction result and response back to the remotely configurable mobile financial application in the mobile client. The configuration server also takes care of converting the sent and received transaction data into a format acknowledged by the platform server and the remotely configurable mobile financial application.

FIG. 6 shows a more detailed exemplary embodiment of the invention in a form of a use case for a service transaction concerning Sending Money in a case of a remotely configurable mobile financial application. In this advantageous embodiment of the invention, the configuration server relies further on three logic layers described in FIG. 6:

The Front-End 602 which is the entry point of the configuration server from the perspective of the remotely configurable mobile financial application in the mobile client device 16-18. The Front-End 602 contains a messaging layer and handles security aspects such as message encryption and decryption by interfacing with a dedicated security module 603, handles communications through communication channels such as SMS or USSD, for example, but not limited to these, especially in a limited connectivity context where only narrow communication channels are usable but through IP channels as well. The Front-End 602 interacts with the Core component 604 of the configuration server. For example, when a user 601 of the remotely configurable mobile financial application in the mobile client device 16-18 requests for some financial transaction such as Send Money 610-613, the Front-End 602 interfaces with a dedicated security module 603 in order to decrypt the received transaction request message 614. After parsing the received message 615 and verifying the request 616, the Front-End 602 forwards the transaction request 617 to the Core 604.

The Core 604 handles the state of the whole system, the business domain and the business logic of the configuration server. When the remotely configurable mobile financial application in the mobile client device 16-18 requests for some financial transaction such as Send Money 610-613, the Core 604 first, after receiving the forwarded transaction request 617 from the Front-End 602, executes internal business logic against its database 605 such as registering the transaction data and its related tracking number 618. After that the Core 604 forwards the transaction request 619 to the Adapter layer 606; and

The Adapter layer 606 is made of Adapter APIs exposing the platform server APIs available and includes implementation to interact with the platform server 10 running the actual financial service platform that will process the actual service transaction such as Send Money 621 and based on its processing provides a response to the specific service transaction such as Send Money 622 back to the Adapter layer of the configuration server 606.

The configuration server 12 takes care of forwarding the received service transaction response back to the remotely configurable mobile financial application in the mobile client device by forwarding the transaction response 623 to the Core 604. The Core 604 runs its internal business logic against its database in order to map the received responses with the previously sent transaction request 624 before forwarding the response to the Front-End 625. The Front-End 602 utilizes the messaging layer to return the service transaction response 626 to the mobile application 16-18 to be displayed 627 to the application user 601.

In addition to the logic layers of the configuration server 12 described above and handling the interactions with the remotely configurable mobile financial application in the mobile client device 16-18 on one side and the platform server 10 running the actual financial service platform on the other side, the configuration server 12 as a sub-system also proposes Web Admin User Interface (Web Admin UI) to define the financial services and forms to be deployed to its remotely configurable mobile financial applications as described in FIG. 7.

FIG. 7 illustrates an exemplary embodiment for initializing and modifying the menu and functionality of a remotely configurable mobile application in a configuration server by utilizing advantageously tools with a Web Admin UI for configuration and shows also the connection of the implemented changes within the mobile application's user interface in three exemplary phases. In first step 701 the initial configuration of the remotely configurable mobile application is advantageously defined at the configuration server 12 through the graphical user interface for configuration and seen also in the mobile application displayed in the mobile client device 205 after the steps for requesting the initial configuration have been executed as presented as an example in FIG. 2. The second phase 702 illustrates that for example, all labels for features and functionalities, text locations and other properties for the mobile application in the mobile client device 16-18 may be defined at the configuration server 12 as part of the initial configuration as in phase 212 in FIG. 2. The third phase 703 illustrates that new functionality to the remotely configurable mobile application may he advantageously added on the configuration server 217 and then updated to the mobile application in the mobile client device 211 as presented in FIG. 2, for example.

An example configuration of the remotely configurable mobile financial application in the mobile client device through the Web Admin UI in the configuration server 12 is further described as follows:
The user of the Web Admin UI in this advantageous embodiment, a money issuer, uses the Web Admin UI in the configuration server to create a financial product basically as a collection of forms and the forms are created to correspond to the available services exposed by the financial service platform running on the platform server such as Send Money, Top Up or Pay Bill, for example, but not limited to these as presented in phase 701;
To create a form, the money issuer needs to select a platform server API corresponding to the financial service in question such as “Send Money to Phone Number”, for example, and each platform server API has an implicit feature or functionality type being materialized as the main menu of the remotely configurable mobile financial application in the mobile client device;
To create a form, the money issuer also needs to provide a form label which is materialized as a sub-menu of the remotely configurable mobile financial application in the mobile client device such as “Send Money to Phone Number”, for example, as presented in phase 702;
To create a form, the money issuer also needs to define input fields of the form, for example Mobile Subscriber ISDN (MSISDN) or amount message, advantageously needed to execute a “Send Money to Phone Number” financial transaction, for example;
The data posted through the created form will be forwarded by the configuration server to the platform server to execute the actual transaction and the form fields may have different data types, such as text, numeric or a list of choice, and different validation schemes, such as phone number, email address or amount, as well as a position within a screen, for example; and
Once the money issuer has defined its products and assigned the corresponding forms, the financial service is ready to be used by the end user.

An example of a first-time use of remotely configurable mobile financial application in the mobile client device is described as follows:
In order to use the service through the remotely configurable mobile financial application in the mobile client device for the first time, an end user first needs to install the initial remotely configurable mobile financial application package or definition file through a download service or side installation like also described on high level in FIG. 2 in phases 201-202, for example;
After the initial installation, the remotely configurable mobile financial application in the mobile client device does not yet contain any features or functionalities of the financial service and service transactions. Therefore the end user runs for example a few-step configuration wizard among which steps he needs to select one of the financial products created and made available by the money issuer through the Web Admin UI on the configuration server as presented as an example in FIG. 7 in phases 701 and 702;
Advantageously, the selection of the financial product triggers communication with the server to request the configuration of the selected product, as for example in FIG. 2 in phases 202-203, and as a response, the user receives the full collection of forms assigned to this product as described on high level in FIG. 2 in phase 204 based on configuration available in phase 212, for example;
Once the forms are stored locally, the remotely configurable mobile financial application in the mobile client device displays a main menu defining the feature and functionality types accessible to the end user as well as all the forms corresponding to the financial transaction services that the end users can utilize as described in FIG. 2 in phase 205 and in FIG. 7 in phases 701 and 702, for example;
Advantageously, the remotely configurable mobile financial application in the mobile client device acts as a rendering engine for the main menu, sub-menus and form definitions received through the communication channel during the configuration and each functionality is displayed dynamically according to the received configuration; and
Advantageously, the communication between the remotely configurable mobile financial application and the configuration server may be based on compressed, encrypted, binary format configuration and management messages that can be passed over a narrow communication channel such as SMS or USSR, for example, even in a low-connectivity context and contain data for configuration of the application or managing the application or service transactions.

The technical effects of the invention as described in the previous exemplary embodiments are formed based on the advantageous factor that once a remotely configurable mobile application in a mobile client device has been set up and configured as described in connection with the previous exemplary embodiments, for example, it is possible to completely renew its functionality without a need to re-install the software package of the application but by simply updating its locally stored forms and, advantageously, the updates can be created in a configuration server, The dynamic nature of the rendering engine of the remotely configurable mobile application means that as soon as a new set of forms has been received from the configuration server, the displayed UI consisting of the menu and functionality of the application is updated straight away and, advantageously, the application stays ready for use without any major disturbance. Such remote control of the application also ensures a full control of the set of services that a service provider exposes to its remotely configurable mobile applications. It also allows easy discarding of unwanted or blacklisted clients by allowing remote disabling and enabling of the application as well blocking and unblocking of the application in a similar remote manner. A financial application is presented as one advantageous embodiment but the same could be applied to several service areas such as insurance related services or rental services, for example.

Another technical effect of the invention is that the configuration of the mobile application is purely independent from the mobile client devices with the remotely configurable mobile application. Therefore the OS of the mobile client device has no significance in the utilization of the invention but instead the invention advantageously is independent of the mobile operating systems. Also, the service platform has very little significance and the invention can be applied to basically any service platform with a simple adaptation.

Also, a further technical effect of the invention is evident in the limited connectivity context as the communication channel required for configuration and management messaging between the configuration server and the remotely configurable mobile application in the mobile client device is very narrow and communication channels such as SMS or USSD, for example, are utilized.

The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A method for remote configuration of a mobile application, the method comprising:
initializing a remotely configurable mobile application in a mobile client device;
constructing an initial menu and related data types for the remotely configurable mobile application in the mobile client device;
implementing remote configuration tools for defining changes on a configuration server to the menu and functionality of the remotely configurable mobile application without requiring reinstallation of the said application in the mobile client device and causing a break in using the said application;
creating encrypted, communication channel independent configuration and management messages between the remotely configurable mobile application in the mobile client device and the configuration server for changing the menu and functionality of the said application remotely and dynamically without requiring re-installation of the said application and causing a break in using the said application in the mobile client device;
changing the menu and functionality of the mobile application remotely and dynamically by utilizing the encrypted, communication channel independent configuration and management messages without requiring re-installation of the said application and causing a break in using the said application in the mobile client device;
disabling, or enabling the use of the remotely configurable mobile application in the mobile client device by utilizing the encrypted, communication channel independent configuration and management messages; and
blocking or unblocking the use of the remotely configurable mobile application in the mobile client device by utilizing, the encrypted, communication channel independent configuration and management messages.

2. The method according to claim 1, wherein a data type is a east one selected from the group of text, list of choice, numeric, or alphanumeric.

3. The method according to claim 1, wherein a dynamic roll-back and recall of configuration and management messages is implemented for a remotely configurable mobile application in a mobile client for changing the menu and functionality of the said application remotely and dynamically according to encrypted, communication channel independent configuration and management messages received from a configuration server.

4. The method according to claim 1, wherein the remotely configurable mobile application is set up to be always ready to receive encrypted, communication channel independent configuration and management messages.

5. The method according to claim 4, wherein an encrypted, communication channel independent configuration message contains configuration data in as serialized and compressed binary format.

6. The method according to claim 4, wherein the communication channel used in configuration and management messages is at least one selected from the group of Internet Protocol Suite (IP Suite), Short Message Service (SMS) or Unstructured Supplementary Service Data (USSD).

7. The method according to claim 1, wherein the remotely configurable mobile application is initially rendered by utilizing a separately installed or downloaded application set-up file in the mobile client device.

8. The method according to claim 1, wherein any single item of a menu, a function, or a set of functions in a menu of the remotely configurable mobile application can be changed separately and dynamically, remotely, without requiring re-installation of the said application and causing as break in the use of the application.

9. The method accomplished by claim 8, wherein changing the remotely configurable mobile application can be modifying the menu cu functions of the said application, adding new features to the menu or functions to the application or removing features from the menu and functionality from the application.

10. A system of remotely configurable mobile application, the system comprising:
at least one configuration server configured to
construct an initial menu, related data types and functionality of a remotely configurable mobile application in a mobile client device;
implement changes to the initial menu and functionality of the remotely configurable mobile application in a mobile client device without re-installing the mobile application and causing a break in the use of the application;
send encrypted, communication channel independent configuration and management messages to the mobile client device with the remotely configurable mobile application for changing the menu of the application remotely and dynamically without requiring reinstallation of the application and causing a break in using the application;
disable or enable use of the remotely configurable mobile application in the mobile client device by utilizing the encrypted, communication channel independent configuration and management messages;
block or unblock use of the remotely configurable mobile application in the mobile client device by utilizing the encrypted, communication channel independent configuration and management messages between the remotely configurable mobile application in the mobile client device and the configuration server;
at least one mobile client device configured to
initialize a menu of the remotely configurable mobile application;
present the menu and functionality for the remotely configurable mobile application for allowing a user to send and receive secure service transactions;
receive encrypted, communication channel independent configuration and management messages from the configuration server and change the menu and functionality of the remotely configurable mobile application according to the received configuration message without requiring re-installation of the application and causing of break in using the application; and
at least one platform server configured to
receive messages from the configuration server containing transaction data;
process transaction data received from the configuration server;
send messages to the configuration server containing a response to the received transaction data; and
store the received and processed transaction data.

11. The system according to claim 10, wherein the mobile device with a remotely configurable mobile application is paired with at least one configuration server, the configuration server is paned with at least one platform server, the platform server is paired with at least one configuration server.

12. The system according to claim 10, wherein the configuration server is configured to receive encrypted, communication channel independent messages containing service transaction data in binary format from a mobile client device with a remotely configurable mobile application.

13. The system according to claim 12, wherein the configuration server is configured to send encrypted, communication channel independent messages containing service transaction data in binary format to the mobile client device with a remotely configurable mobile application and the mobile client device with the remotely configurable mobile application is configured to receive the messages containing service transaction data.

14. The system according to claim 10, wherein the configuration server is configured to send messages containing, service transaction data to the platform server and the service transaction data is converted into a format acknowledged by the platform server.

15. The system according to claim 14, wherein the configuration server is configured to receive messages containing service transaction data from the platform server and convert the received service transaction data to a format acknowledged by the remotely configurable mobile application in a mobile client device.

16. The system according to claim 13, wherein the mobile client device with the remotely configurable mobile application is configured to be always ready to receive encrypted, communication channel independent configuration and management messages from the configuration server.

17. The system according to claim 16, wherein a communication channel used in sending and receiving encrypted messages is in least one selected from the group of Internet Protocol Suite (IP), Short Message Service (SMS) or Unstructured Supplementary Service Data (USSD).

18. The system according to claim 16, wherein the encrypted, communication channel independent configuration message contains configuration data in a serialized and compressed binary format.

19. The system according to claim 16, wherein the mobile client device with the remotely configurable mobile application is provided with a dynamic roll-back and recall of configuration and management messages for changing the menu and functionality of the application remotely and dynamically according to configuration and management messages received from the configuration server.

20. The system according to claim 10, wherein the mobile client device and the platform server are configured to run on any operating system.

21. The system according to claim 10, wherein a data type is at least one selected from the group of text, list of choice, numeric, or alphanumeric.

22. A non-transitory computer readable storage medium having computer-executable components for remote configuration of a mobile application comprising:
computer readable code for initializing a remotely configurable mobile application in a mobile client device;
computer readable code for constructing an initial menu, related data, types and functionality for the remotely configurable mobile application;
computer readable code for configuring the menu and functionality of the remotely configurable mobile application remotely by utilizing encrypted, communication channel independent configuration and management messages without requiring re-installation of the application and causing a break in using the application;
computer readable code for sending encrypted, communication channel independent configuration and management messages to the remotely configurable mobile application in the mobile device;
computer readable code for disabling or enabling, the use of the remotely configurable mobile application in the mobile client device by the utilizing encrypted, communication channel independent configuration and management messages; and
computer readable code for blocking or unblocking the use of the remotely configurable mobile application in the mobile Client device by utilizing encrypted, communication channel independent configuration and management messages.

23. The non-transitory computer readable storage medium according to claim 22 further comprising computer readable code for converting the service transaction data into a format acknowledged by a platform server and sending messages containing the converted service transaction data to the platform server.

24. The non-transitory computer readable storage medium according to claim 22, wherein the computer-executable components are configured to be independent of the operating system of a mobile client device or the platform server.

25. The non-transitory con purer readable storage medium according to claim 22 further comprising computer readable code for receiving messages containing service transaction data from a platform server and converting the received service transaction data to a format acknowledged by the remotely configurable mobile application in the mobile client device.

26. The non-transitory computer readable storage medium according to claim 22 further comprising computer readable code for sending encrypted, communication channel independent messages containing service transaction data in binary format to the remotely configurable mobile application in the mobile device.

27. The non-transitory computer readable storage medium according to claim 26 further comprising computer readable code for receiving encrypted, communication channel independent messages containing service transaction data in binary format from the remotely configurable mobile application in the mobile device.

28. The non-transitory computer readable storage medium according to claim 22, wherein any encrypted, communication channel independent, configuration message contains configuration data m a serialized and compressed binary format.

29. The non-transitory computer readable storage medium according to claim 28, wherein communication channel utilized in sending and receiving encrypted configuration and management messages is at least one selected from the group of Internet Protocol Suite (IP), Short Message Service (SMS) or Unstructured Supplementary Service Data (USSD).

30. The non-transitory computer readable storage medium according to claim 22, wherein a data type is at least one selected from the group of text, list of choice, numeric, or alphanumeric.

31. A non-transitory computer readable storage medium having computer-executable components for a remotely configurable mobile application comprising:
computer readable code for initializing a menu for a remotely configurable mobile application;
computer readable code for receiving encrypted, communication channel independent configuration and management messages from a configuration server;
computer readable code for executing configuration of the menu and functionality of the remotely configurable mobile application through remote, encrypted, communication channel independent configuration and management messages without requiring re-installation of the application and causing a break in using the said application;

32. The non-transitory computer readable storage medium according to claim 31, wherein the computer-executable components are configured to run on any mobile device operating system.

33. The non-transitory computer readable storage medium according to claim 31, further comprising computer readable code for sending encrypted, communication channel independent messages to the configuration server containing service transaction data in a compressed and serialized binary format.

34. The non-transitory computer readable storage medium according to claim 33, further comprising computer readable code for receiving encrypted, communication channel independent messages from the configuration server containing service transaction data in a compressed and serialized, binary format.

35. The non-transitory computer readable storage medium according to claim 31, wherein an encrypted, communication, channel independent configuration message contains configuration data in a serialized and c pressed binary format.

36. The non-transitory computer readable storage medium according to claim 35, wherein a communication channel used in sending and receiving an encrypted configuration and management message is at least one selected from the group of Internet Protocol Suite (IP), Short Message Service (SMS) or Unstructured Supplementary Service Data (USSD).

37. The non-transitory computer readable storage medium according to claim 35, further comprising computer readable code for providing a dynamic roll-back and recall of the configuration and management messages for changing the menu and functionality of a remotely configurable mobile application remotely and dynamically according to encrypted, communication channel independent configuration and management messages received from the configuration server.

38. The non-transitory computer readable storage medium components according to claim 11, further comprising computer readable code for being always ready to receive encrypted, communication channel independent configuration and management messages from the configuration server.
